(19) United States
(12) Patent Application Publication
(10) Pub. No.: US 2006/0097604 A1
(43) Pub. Date: May 11, 2006

(54) Electric motor and motor-driven compressor

(76) Inventors: Taku Adaniya, Kariya-shi (JP); Ai Saeki, Kariya-shi (JP); Masatoshi Kobayashi, Kariya-shi (JP)

Correspondence Address: MORGAN & FINNEGAN, L.L.P., 3 World Financial Center, New York, NY, 10281-2101, US

(21) Appl. No.: 11/233,764

(22) Filed: Sep. 22, 2005

(30) Foreign Application Priority Data
Nov. 5, 2004 (JP) 2004-322354

(51) Int. Cl. H02K 1/22

(52) U.S. Cl. 310/261

(57) ABSTRACT

An electric motor, which has a stator and a rotor including a permanent magnet, has a guide for guiding movably in an axial direction of the rotor and an actuator which is operable to move the rotor axially. In addition, a motor-driven compressor includes the electric motor for compressing and discharging gas in its compression chamber by compression of the compressor based upon rotation of its rotary shaft driven by the electric motor.

### TECHNICAL FIELD

The present invention relates to an electric motor and a motor-driven compressor.

The electric motor is operable under a condition where the sum of induced voltage and voltage dropped in the electric motor (which is due to current flowing in a coil of the electric motor) is the same as or below the output voltage from an inverter to the electric motor. The induced electromotive force (or induced voltage) of the electric motor is determined by the magnetic flux developed by permanent magnet provided in a rotor of the electric motor and angular velocity of the electric motor. That is, the induced voltage of the electric motor increases in proportion to an increase of the angular velocity of the electric motor. As the induced voltage becomes dominant, the electric current that can be supplied to the electric motor is reduced. Since the torque developed by the electric motor is increased in proportion to an increase of the electric current supplied to the motor, it is difficult for the motor to develop a high torque in a high-speed region of the electric motor where the induced voltage becomes dominant.

To solve the above problem, some electric motors use a means for expanding the high-speed region of the electric motor by weak field control. According to this prior art, however, it is necessary to increase the electric current for the weak field control in accordance with the magnitude of the induced electromotive force which increases in proportion to the angular velocity of the electric motor and, therefore, the operating efficiency of the electric motor deteriorates in its high-speed region.

An inner rotor type electric motor disclosed in Japanese unexamined patent publication No. 2002-262534 widens the high-speed range without using weak field control. This electric motor has a rotor including permanent magnets having different poles which are arranged alternately as seen in the rotational direction of the rotor. The rotor is axially divided into two halves and one of them is axially movable. In the high-speed range of the motor, the movable rotor half is spaced away from the other rotor half, so that the centers of magnetic poles of the permanent magnets of the two movable rotor halves are shifted out of alignment. By so doing, the quantity of effective magnetic flux from the permanent magnets is reduced.

The above-described inner rotor type electric motor which is disclosed in the Japanese unexamined patent publication No. 2002-262534 can avoid a decrease in the efficiency of the electric motor in the high-speed range.

The present invention is directed to providing an electric motor and a motor-driven compressor which widen the high-speed range without using the weak field control.

### SUMMARY

In accordance with the present invention, an electric motor having a stator and a rotor including a permanent magnet has a guide for guiding movably in an axial direction of the rotor and an actuator operable to move the rotor axially.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a longitudinal cross-sectional view of a motor-driven compressor according to a first preferred embodiment of the present invention;

FIG. 2 is a cross-sectional view that is taken along the line I-I in FIG. 1;

FIG. 3 is a cross-sectional view that is taken along the line II-II in FIG. 1;

FIG. 4 is a partially enlarged cross-sectional view of the motor-driven compressor according to the first preferred embodiment of the present invention;

FIG. 5 is a partially enlarged cross-sectional view of a motor-driven compressor according to a second preferred embodiment of the present invention; and

FIG. 6 is a partially enlarged cross-sectional view of the motor-driven compressor according to an alternative embodiment of the present invention.

### DETAILED DESCRIPTION OF THE PREFERRED EMBODIMENTS

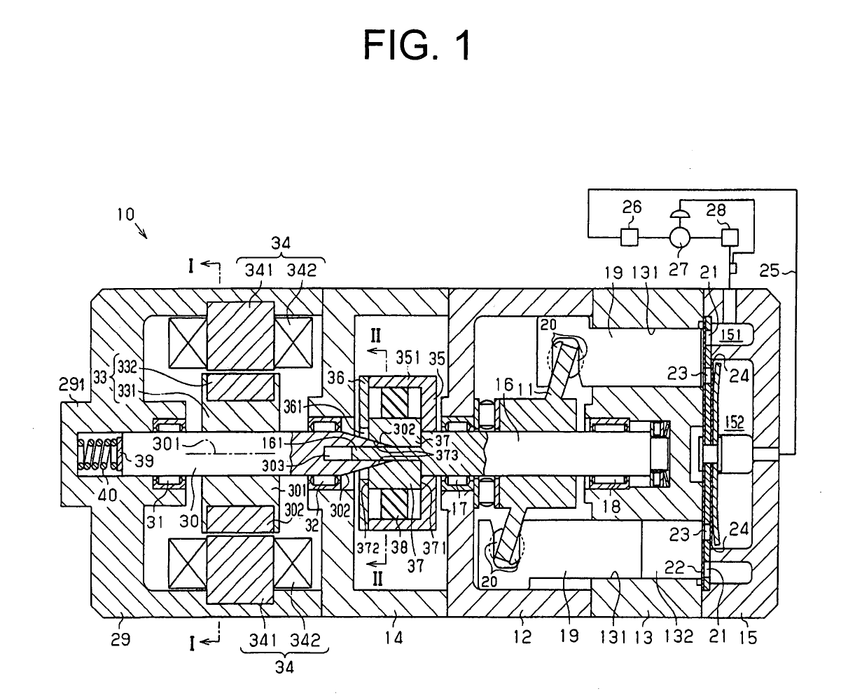

A first preferred embodiment of an electric motor and a motor-driven compressor of a fixed displacement piston type according to the present invention will now be described with reference to FIGS. 1 through 4.

As shown in FIG. 1, the compressor includes a cam housing 12 accommodating therein a swash plate 11 and connected at one end thereof to a cylinder block 13 and at the other end thereof to a center housing 14. A rear housing 15 is connected to the cylinder block 13 and a motor housing 29 is connected to the center housing 14. The cam housing 12, the cylinder block 13, the center housing 14, the rear housing 15 and the motor housing 29 cooperate to form the housing of the motor-driven compressor 10. The cam housing 12 and the cylinder block 13 rotatably support a rotary shaft 16 through radial bearings 17, 18. The swash plate 11 is fixed on the rotary shaft 16 for rotation therewith in the cam housing 12.

The cylinder block 13 has formed therethrough a plurality of cylinder bores 131. Each cylinder bore 131 accommodates therein a piston 19. Torque of the swash plate 11 is transmitted to the pistons 19 through a pair of shoes 20 in a known manner. As the swash plate 11 is driven to rotate by the rotary shaft 16, each piston 19 is moved reciprocally in its associated cylinder bore 131. A compression chamber 132 is defined by the piston 19 and the cylinder bore 131.

The rear housing 15 has formed therein a suction chamber 151 and a discharge chamber 152. As the piston 19 moves from the top dead center toward the bottom dead center (or leftward as seen in FIG. 1), refrigerant gas in the suction chamber 151 is drawn into the compression chamber 132 through a suction port 21 while pushing open a suction valve 22. As the piston 19 moves from the bottom dead center toward the top dead center (or rightward as seen in FIG. 1), on the other hand, refrigerant gas is compressed in the compression chamber 132 and then discharged out thereof into the discharge chamber 152 through a discharge port 23 while pushing open a discharge valve 24.

The suction chamber 151 and the discharge chamber 152 are connected to an external refrigerant circuit 25, respectively, as shown schematically in FIG. 1. The external refrigerant circuit 25 includes a condenser 26 for radiating heat from refrigerant gas thereby to condense the refrigerant, an expansion valve 27 and an evaporator 28 for transferring the ambient heat to the refrigerant. Refrigerant gas in the discharge chamber 152 flows out into the external refrigerant circuit 25 and returns to the suction chamber 151.

An electric motor M having an output shaft 30 is disposed in the motor housing. The output shaft 30 of the motor M is axially movably supported by radial bearings 31, 32 in the motor housing and the center housing 14, respectively. The radial bearings correspond to a guide in this embodiment. One end of the output shaft 30 extends into the center housing 14 and has therein an internally splined hole 303. One end of the rotary shaft 16 protrudes into the center housing 14 and has an externally splined protrusion 161. As shown in FIGS. 1 and 3, the protrusion 161 of the rotary shaft 16 is fitted in the hole 303 of the output shaft 30 of the electric motor M by spline engagement. Thus, the output shaft 30 and the rotary shaft 16 are connected in the center housing 14 in such a way that the output shaft 30 of the electric motor M is axially movable while being rotated together with the rotary shaft 16.

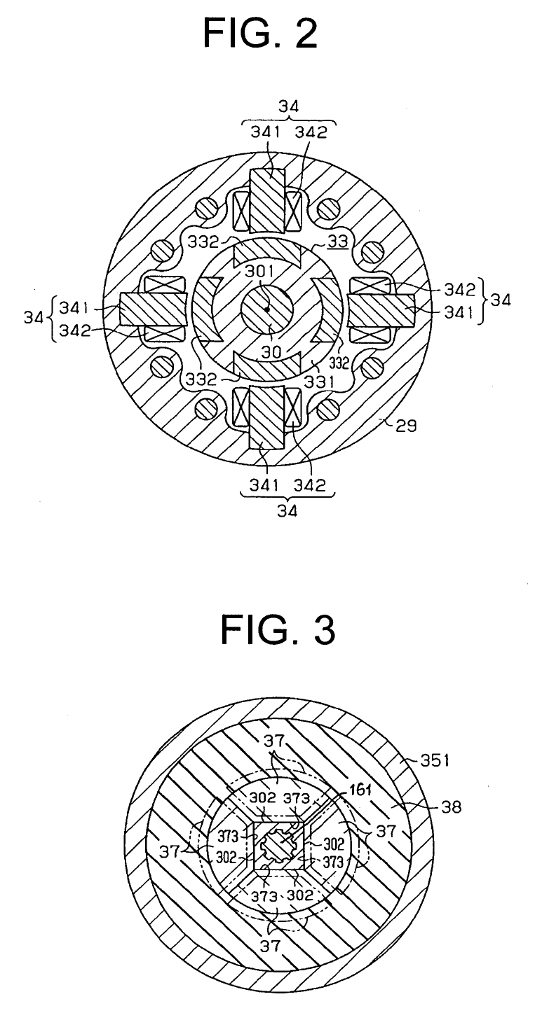

As shown in FIG. 2, the electric motor M has a rotor 33 which is fixed on the output shaft 30 in the motor housing 29 and a plurality of stators 34 which are provided on the inner peripheral surface of the motor housing 29. The rotor 33 includes a rotor core 331 fixed on the output shaft 30 and a plurality of permanent magnets 332 provided on the circumferential surface of the rotor core 331. The permanent magnets 332 are disposed such that any two adjacent permanent magnets 332 have different magnetic poles on the side thereof adjacent to the stators 34.

Each stator 34 includes a stator core 341 and a coil wound around the stator core 341. The rotor 33 and hence the output shaft 30 are rotated when electric current is supplied to the coil 342. The rotary shaft 16 and the swash plate 11 rotate integrally with the output shaft 30. Therefore, the speed of the compressor coincides with the speed of the electric motor M.

As shown in FIG. 1, the output shaft 30 which is a part of the rotor 33 is axially movably supported by the radial bearings 31, 32. The radial bearings 31, 32 serve as a guide means for guiding the rotor 33 moving in its axial direction.

In the center housing 14, a disc-shaped guide plate 35 is fixed on the rotary shaft 16. The guide plate 35 is formed at the outer periphery thereof with an integral cylindrical portion 351. A disc-shaped guide plate 36 is fixed to the distal end surface of the cylindrical portion 351. The guide plate 35 is in parallel relation to the guide plate 36. A plurality of movable bodies 37 (four such bodies in the illustrated embodiment, each being fan-shaped, as shown in FIG. 3) is accommodated between the guide plates 35, 36. The movable bodies 37 are arranged equidistantly around the axis 301 of the output shaft 30. Each body 37 is movable radially of the rotor 33. One end surface 371 of the movable body 37 slides on the guide plate 35, while the other end surface 372 of the movable body 37 slides on the guide plate 36.

The cylindrical portion 351 has therein an annular elastic member 38 which is made of rubber and urges the movable bodies 37 radially inward of the output shaft 30.

The guide plate 36 is formed at its center with a shaft hole 361. One end of the output shaft 30 passes through the shaft hole 361 and extends into the space between the guide plates 35, 36. Four planar inclined surfaces 302 are formed on one end of the output shaft 30 between the guide plates 35, 36, while four planar cam surfaces 373 are formed on the movable bodies 37 so as to be contactable in area with the inclined surfaces 302. Referring to FIGS. 1 and 3, the one end of the output shaft 30 is formed with four planar surfaces 302 each of which is inclined at an angle with respect to the axis 301 of the output shaft 30 so that a quadrilateral pyramid formed by the one end, while each movable body 37 has a planar cam surface 373 formed so as to be contactable with each one of the inclined surfaces 302 of the output shaft 30, as shown specifically in FIG. 3.

A race 39 and a compression spring 40 are interposed between the end wall 291 of the motor housing 29 and the end surface of the output shaft 30. The compression spring 40 urges the output shaft 30 in its axial direction through the race 39 so that the inclined surfaces 302 of the output shaft 30 and the cam surfaces 373 of the movable bodies 37 are pressed against each other by the urging force of the compression spring 40.

FIG. 1 shows a state of the compressor 10 where the electric motor M is at a stop. In this state, the elastic member 38 is elastically deformed and the movable bodies 37 are pressed against the circumferential surface of the protrusion 161 of the rotary shaft 16 by the elastic force of the deformed elastic member 38. That is, the elastic member 38 provides the movable bodies 37 with a preload of predetermined magnitude which causes the movable bodies 37 to be in contact with the protrusion 161 of the rotary shaft 16. The compression spring 40 is compressed, producing an urging force to press the inclined surfaces 302 of the output shaft 30 against the cam surfaces 373 of the movable bodies 37. That is, the urging force of the compression spring 40 acts on the movable bodies 37 through the engagement between the inclined surfaces 302 and the cam surfaces 373 thereby to urge the movable bodies 37 radially outward.

When the electric motor M is running, the four movable bodies 37 are subjected to centrifugal force resulting from the rotation of the output shaft 30 (the rotor 33) and acting in radially outward direction. When the sum of the centrifugal force acting on the movable bodies 37 and the above radial urging force of the compression spring 40 acting on the movable bodies 37 exceeds the aforementioned preload by the elastic member 38, the movable bodies 37 are moved radially outwardly. Then, the output shaft 30 is moved in axial direction thereof with the rotor 33 mounted thereof rightward as seen in FIG. 1 by the urging force of the compression spring 40.

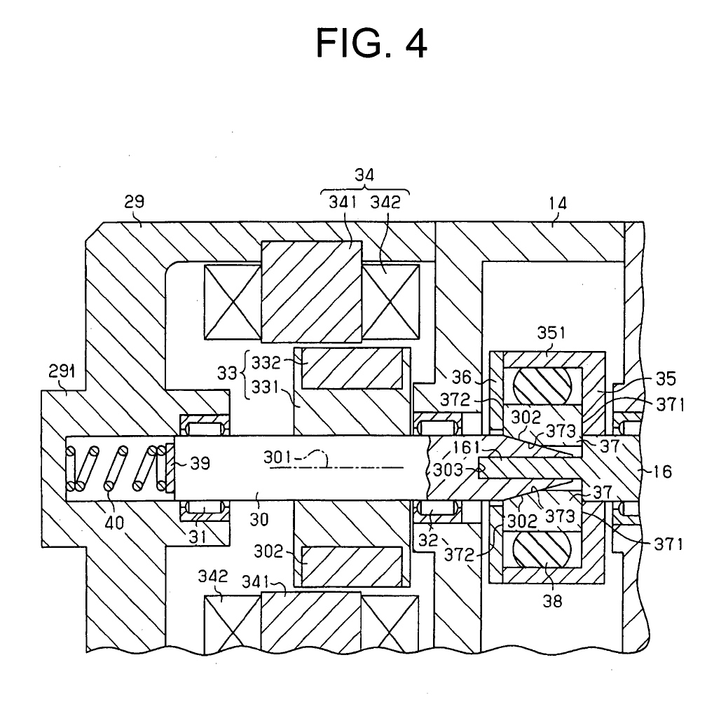

FIG. 4 shows a state of the compressor 10 where the electric motor M is running at a high speed. In the state shown in FIG. 4, the movable bodies 37 are spaced apart from the protrusion 161 of the rotary shaft 16 by the centrifugal force resulting from the high-speed rotation of the rotor 33. As apparent from FIG. 4, the elastic member 38 is then deformed further than the state of FIG. 1. The distal end of the protrusion 161 contacts the bottom of the hole 303, and the movable bodies 37 are spaced farthest away from the peripheral surface of the protrusion 161, accordingly.

As the movable bodies 37 are moved radially inward by the elastic force of the elastic member 38, the inclined surfaces 302 of the output shaft 30 are pressed by the cam surfaces 373, and the output shaft 30 and hence the rotor 33 are moved axially so as to increase the facing area between the rotor 33 and the stator 34.

The elastic member 38 functions as an elastic urging means for urging the movable bodies 37 radially inward. The elastic member 38 functions also as a preloading means for preloading the movable bodies 37. The compression spring 40 functions as an urging means for urging the rotor 33 axially. The preloading means, the urging means, the inclined surfaces 302 and the cam surfaces 373 cooperate to form an interlocking means for moving the rotor 33 axially in conjunction with the movement of the movable bodies 37. Then, the movable bodies 37 and the interlocking means cooperate to form an actuator which is operable to move the rotor axially using the centrifugal force.

According to the first preferred embodiment, the following advantages are obtained.

(1-1) When the electric motor M is running at a higher speed, the movable bodies 37 are spaced radially farther away from the axis 301 of the rotor 33 and the rotor 33 is moved axially, accordingly. This movement of the rotor 33 reduces the facing area between the rotor 33 and the stator 34. This reduction of the facing area reduces the magnitude of induced electromotive force (induced voltage) during the high-speed operation of the electric motor M. That is, a decrease in the efficiency of the electric motor M in the high-speed range is prevented and the high-speed range of the electric motor M is widened.

(1-2) As the centrifugal force acting on the movable bodies 37 exceeds the preload, the movable bodies 37 are moved radially outward and the rotor 33 is moved axially, accordingly. The speed of the electric motor M (in terms of rpm) at which the magnitude of induced electromotive force begins to be controlled for reduction may be set as desired by determining the magnitude of preload appropriately. Such determination of the preload is preferable for appropriately reducing the magnitude of induced electromotive force in connection with the speed of the electric motor M.

(1-3) The rubber elastic member 38 which requires only a small space for installation is a suitable elastic urging means for setting the preload.

(1-4) The structure which allows the cam surfaces 373 to slide in contact with the inclined surfaces 302 for moving the rotor 33 axially in conjunction with the radial movement of the movable bodies 37 is advantageously simple.

(1-5) The provision of plural movable bodies 37 at equiangular positions around the axis 301 of the rotor 33 permits the rotor 33 to move axially smoothly in conjunction with the radial movement of the movable bodies 37.

(1-6) When the fixed-displacement motor-driven compressor 10 is operating at a high speed, the discharge pressure of refrigerant gas is high and the load torque on the compressor 10 is large, accordingly. For a compressor which operates in the high-speed range and on which the large load torque is applied, the electric motor M which is operable at the high torque is suitable as a drive source of the compressor.

(1-7) The output shaft 30 of the rotor 33 is in spline engagement with the rotary shaft 16 of the compressor. The spline engagement is a suitable structure for the output shaft 30 of the rotor 33 to be movable axially relative to the rotary shaft 16 and for transmitting the rotation of the output shaft 30 of the rotor 33 to the rotary shaft 16.

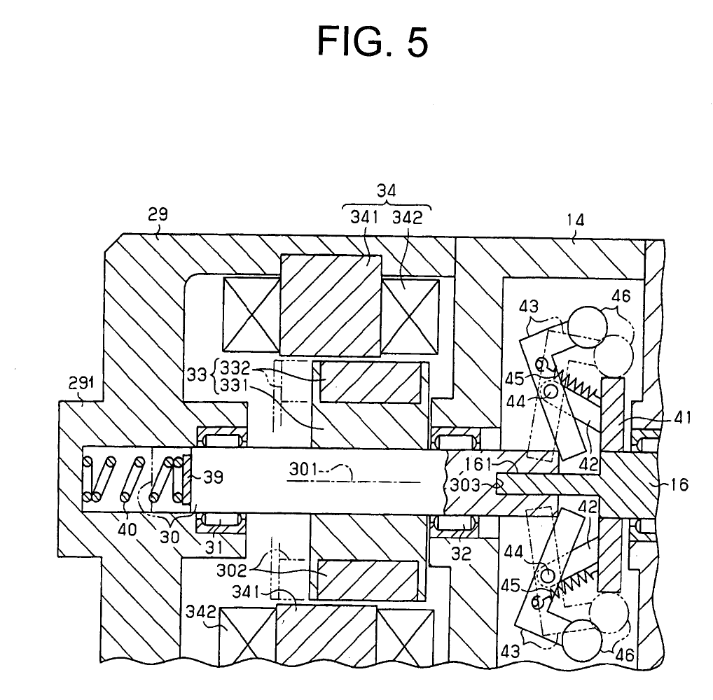

The following will describe a second preferred embodiment of the invention with reference to FIG. 5. The same reference numerals denote the substantially similar components or elements to those of the first preferred embodiment.

The rotary shaft 16 is in spline engagement with the output shaft 30. An annular base plate 41 is fixedly mounted on the rotary shaft 16. A pair of support brackets 42 is secured to one end face of the base plate 41 and Levers 43 are supported pivotally about respective shafts 44 by the respective support brackets 42. A spring 45 is interposed between each lever 43 and the base plate 41 and one end of the lever 43 is pressed against the rear end of the output shaft 30. A weight 46 is secured to the other end of each lever 43. The base plate 41, the levers 43 and the weights 46 are rotatable integrally with the output shaft 30 and the rotary shaft 16.

When the electric motor M is at a stop, the levers 43 and the weights 46 are at the position indicated by the dotted line in FIG. 5 by the urging force of the spring 45. With the levers 43 and the weights 46 thus positioned, the weights 46 are in contact with the outer periphery of the base plate 41. Focusing on the upward lever 43, shaft 44, spring 45 and weight 46 in FIG. 5, the lever 43 is prevented from pivoting clockwise about the shaft 44. The lever 43 and the weight 46 are preloaded by the urging force of the spring 45 so as to pivot clockwise about the shaft 44. The urging force of the compression spring 40 acts on the lever 43 through the output shaft 30. Thus, the lever 43 is loaded by the urging force of the compression spring 40 so as to pivot counterclockwise about the shaft 44. The clockwise moment Mo due to the preload which acts clockwise about the shaft 44 is set greater than the counterclockwise moment M1 due to the load which acts counterclockwise about the shaft 44 by the urging force of the compression spring 40.

When the electric motor M is running, the lever 43 and the weight 46 are urged counterclockwise around the shaft 44 by the centrifugal force due to the rotation of the output shaft 30 (the rotor 33). When the sum of the counterclockwise moment M2 due to the load which acts counterclockwise around the shaft 44 and the moment M1 exceeds the moment Mo because of an increase of the above urging force, the lever 43 and the weight 46 are pivoted counterclockwise about the shaft 44. Accordingly, the output shaft 30 and the rotor 33 are moved axially from the motor housing 29 toward the center housing 14 by the urging force of the compression spring 40.

In FIG. 5, when the levers 43 are at the position indicated by the solid line, the electric motor M is running at a high speed. In this state, the weights 46 are positioned away from the outer periphery of the base plate 41 by the centrifugal force due to the high speed rotation of the rotor 33 and the distal end of the protrusion 161 is placed in contact with the bottom of the hole 303. Therefore, the weights 46 are placed farthest away from the outer periphery of the base plate 41 by the contact between the distal end of the protrusion 161 and the bottom of the hole 303.

The springs 45 function as an elastic urging means for urging their associated weights 46, or the movable bodies, radially outward. The springs 45 also function as a preloading means for preloading the weighs 46. The compression spring 40 functions as an urging means for urging the rotor axially. The preloading means, the urging means and the levers 43 cooperate to form an interlocking means for moving the rotor 33 axially in conjunction with the movement of the weights 46. Then, the weights 46 and the interlocking means cooperate to form an actuator which is operable to move the rotor 33 axially using the centrifugal force.

According to the second preferred embodiment, the same advantages as the above-mentioned (1-1), (1-2), (1-6) and (1-7) of the first preferred embodiment are obtained.

The present invention is not limited to the embodiments described above but may be modified into various alternative embodiments as exemplified below.

(1) In an alternative embodiment to the first preferred embodiment, instead of the rubber elastic member 38, a coil-shaped compression spring is used for each movable body 37.

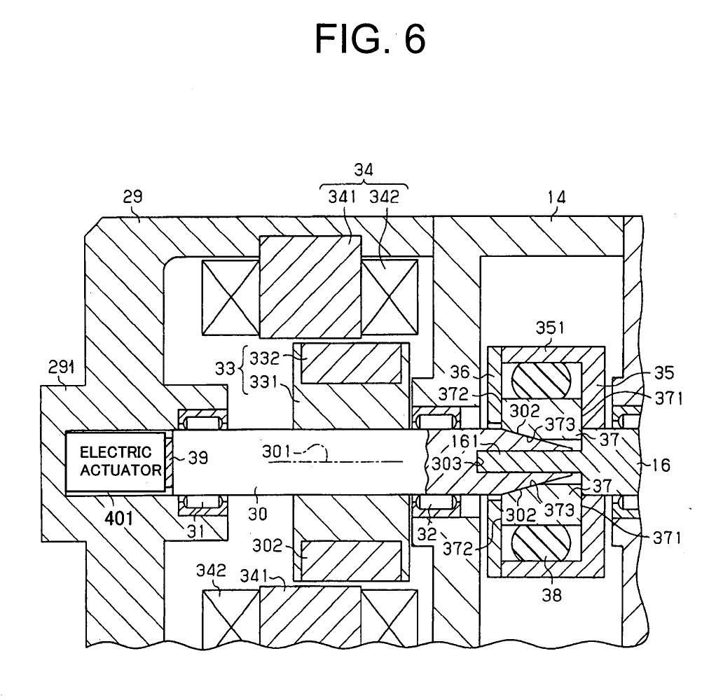

(2) In an alternative embodiment as shown in FIG. 6, the rotor is moved axially by an electric actuator 401 which is operable in response to a command such as electrical signal.

(3) In the first and second preferred embodiments, the electric motor is of an inner rotor type which has the stator arranged around the rotor having permanent magnets. In an alternative embodiment, however, the present invention is applicable to an outer rotor type electric motor which has a rotor having permanent magnets arranged around a stator for rotation therearound.

(4) In an alternative embodiment, the present invention is applicable to a scroll type compressor.

(5) In an alternative embodiment, the present invention is applicable to a variable displacement motor-driven compressor.

Therefore, the present examples and embodiments are to be considered as illustrative and not restrictive, and the invention is not to be limited to the details given herein but may be modified within the scope of the appended claims.

What is claimed is:

1. An electric motor having a stator and a rotor including a permanent magnet, comprising:
a guide for guiding movably in an axial direction of the rotor; and
an actuator operable to move the rotor axially.

2. The electric motor according to claim 1, wherein the actuator is operable to move the rotor using centrifugal force.

3. The electric motor according to claim 2, wherein the actuator includes:
a movable body movable radially of the rotor; and
an interlocking means for moving the rotor axially in conjunction with movement of the movable body, wherein the movable body is moved radially outward by centrifugal force acting on the movable body resulting from rotation of the rotor.

4. The electric motor according to claim 3, wherein the interlocking means includes:
an urging means for urging the rotor axially; and
a preloading means for preloading the movable body radially inward of the rotor against centrifugal force, wherein the movable body is preloaded by the preloading means.

5. The electric motor according to claim 4, wherein the preloading means is an elastic urging means for urging the movable body radially inward by elastic force.

6. The electric motor according to claim 5, wherein the elastic urging means is a rubber elastic member or a spring.

7. The electric motor according to claim 4, wherein the rotor has an output shaft which includes an inclined surface inclined relative to an axis of the output shaft, wherein the movable body has a cam surface which is in slide contact with the inclined surface, and wherein the inclined surface and the cam surface are parts of the interlocking means.

8. The electric motor according to claim 4, wherein a plurality of the movable bodies are arranged equidistantly around an axis of the rotor.

9. The electric motor according to claim 1, wherein the actuator is an electric actuator.

10. The electric motor according to claim 1, wherein the stator is arranged around the rotor.

11. A motor-driven compressor having the components of claim 1 for compressing and discharging gas in its compression chamber by compression of the compressor based upon rotation of its rotary shaft driven by the electric motor.

12. The motor-driven compressor according to claim 11, wherein an output shaft of the rotor is in spline engagement with the rotary shaft.

13. The motor-driven compressor according to claim 11, wherein the compressor is a swash plate type.

14. The motor-driven compressor according to claim 11, wherein the compressor is a fixed displacement type.
